(19) United States
(12) Patent Application Publication
(10) Pub. No.: US 2017/0264100 A1
(43) Pub. Date: Sep. 14, 2017

(54) SYSTEM FOR STORING ELECTRICAL POWER

(71) Applicant: Bradford G. BARUH, Hillsborough, CA (US)

(72) Inventor: Bradford G. BARUH, Hillsborough, CA (US)

(21) Appl. No.: 15/440,700

(22) Filed: Feb. 23, 2017

Related U.S. Application Data
(63) Continuation of application No. 14/000,046, filed on Oct. 25, 2013, now abandoned.
Application No. 14/000,046 is a continuation of application No. 13/030,386, filed on Feb. 18, 2011, now abandoned.

(51) Int. Cl. H02J 3/38; H02J 7/00; H02K 7/18; H02S 20/30; F03D 9/00; H02S 10/12; H02S 10/20; H02J 7/35; F03D 9/25

(52) U.S. Cl. CPC H02J 3/386; H02J 3/383; H02J 7/35; H02J 7/0055; H02K 7/1838; F03D 9/257; F03D 9/007; H02S 10/12; H02S 10/20; H02S 20/30

(57) ABSTRACT

A wind turbine, which includes a base, a tower, the tower having a cavity therein, which houses a rechargeable battery, and one or more blades, which produce a source of electricity, which is stored in the rechargeable battery housed in the tower of the wind turbine.

### FIELD OF THE INVENTION

This invention generally relates to a system and method of reducing leeway drift of a sailboat as the sailboat reaches an upwind objective by adjusting the location and position of the foresail (i.e., headsail, jib, genoa, or spinnaker) and/or adjusting the depth of the keel and/or keel foil, and more particularly to a system and method of adjusting the location and position of the foresail (headsail, jib, genoa, or spinnaker) on a sailboat by moving the location or position of the foresail and the forestay relative to the bow of the sailboat and/or by adjusting the depth of the keel and/or keel foil.

### BACKGROUND

Typically, a sailboat includes a hull that sits in the water, a mast extending upwardly from the hull, sails supported by the mast, and either a centerboard or fixed keel extending downwardly from the hull into the water. The sails catch the wind and cause the hull to move forwardly through the water. Although, a sailboat cannot sail directly into the wind, a sailboat can sail in a generally windward direction. It can be appreciated that with skill and a combination of maneuvers, a sailor can maneuver a sailboat in almost any desired direction.

Because of the design of the sails, a sailboat can sail to windward, which is typically in a direction no less than about 15 to 25 degrees from the wind, depending upon the design of the boat and the skill of the sailor. Headway directly upwind or windward is typically achieved in a series of sequential maneuvers called tacks, in which the boat is first sailed windward with the wind over one side of the bow, and then turned through the wind so that the wind comes over the other side of the bow. In each tack, some headway upwind is achieved even though the boat does not move directly into the wind, and eventually the sailboat reaches an upwind objective after sailing a zig-zag course covering a distance greater than the straight line distance from the initial position to the upwind objective.

When a sailboat sails to windward, the forces on the sails can be resolved into a thrust component that moves the sailboat forwardly through the water and a drift component that pushes the sailboat sideways in a downwind direction. The sailboat therefore moves in a net direction that is forward, but also is slight downwind opposite to the net intended direction of movement. The sideways drift is called leeway or “slide slipping,”

The downwardly projecting centerboard or keel of the sailboat offers resistance to the leeway produced by the sideways sail force, but at least some leeway remains. This leeway is being constantly accumulated, as there is a downwind movement as long as the sailboat is being sailed into the wind. The leeway significantly increases the time required for the sailboat to sail from its downwind starting position to the upwind objective, as it forces the sailboat to sail much further to make up for the accumulated sideways movement.

Attempts have been made to reduce the amount of leeway. For example, a movable centerboard or fixed keel extending into the water below the sailboat presents a broad surface to resist sideways drift. There have also been attempts to modify the shape of the centerboard or keel to provide a lifting force to counteract the sideways drift. These attempts have been based upon the observation that the centerboard or keel moving through the water is somewhat similar to the wing of an airplane that creates a lift as the wing is moved through the air. The lift of an airplane wing causes the airplane to move upward against the force of gravity, and the corresponding lift of a sailboat centerboard or keel that extends downwardly can cause the sailboat to be lifted in the upwind direction, thereby countering the sideways drift producing the leeway.

Fixed keels are typically used in larger sailboats. The keels are usually filled with lead or other dense material to act as ballast for the sailboat. For example, the keels of 12-meter sailboats may extend 10 feet below the surface of the water, and weigh 40,000 to 50,000 pounds.

It would be desirable to have a system or method of adjusting or changing the relative position of the fixed connection of the foresail, such that the angle of attack in the windward direction is slightly altered in the direction of the wind. Accordingly, it would be desirable to have a system and/or method of changing the angle or direction of the boat in a windward direction and/or use of an extendable keel, which is capable of providing a lifting force to counteract leeway, and is sufficiently reliable to be acceptable for general and racing use.

In addition, it would be desirable to have a retractable solar panel system, which can provide a source of energy to the sailboat. The solar panel system can be attached to a nautical stay, wherein the stay is fixed at one end to a hull of the sailboat and at a second end to a mast of the sailboat. The solar panel system includes a plurality of solar panels, which are attached to a system for extending and retracting the plurality of solar panels, such that when not in use, the solar panels can be stacked.

### SUMMARY

In accordance with one embodiment, a system for sailing windward comprises: a moveable track fixture; a fixed track configured to receive the track fixture; and a control system for securing the location of the track fixture within the fixed track relative to a bow of a sailboat.

In accordance with a further embodiment, a sailboat comprises: a hull; a mast; a plurality of sails, wherein at least one of the plurality of sails is a foresail; and a system for sailing windward comprising: a moveable track fixture; a fixed track configured to receive the track fixture; a control system for securing the location of the track fixture within the fixed track relative to a bow of a sailboat; and a forestay attached to the track fixture, the forestay extending from an upper portion of a mast of a sailboat to the moveable track fixture on a bow of the sailboat.

In accordance with another embodiment, a method of reducing leeway drift of a sailboat as the sailboat reaches an upwind objective, the method comprises changing the relative position of a foresail to a bow of the sailboat without changing the relative position of a mainsail and the foresail to one another.

In accordance with a further embodiment, a sailboat comprises: at least one hull; a mast; a plurality of sails, wherein at least one of the plurality of sails is a foresail; and a system for sailing windward comprising: a foresail beam attached to the mast of the sailboat at a mast end of the foresail beam and receives a leading edge of the foresail at a bow end of the foresail beam; and a foresail track, which extends from a starboard side to a port side of the sailboat and assists the foresail beam in movement from side to side.

In accordance with another embodiment, a sailboat comprises: two or more hulls; a plurality of sails, wherein at least one of the plurality of sails is a foresail; and a system for sailing windward, which includes a foresail track, which receives a leading edge of the foresail and extends from one of the two or more hulls to another of the two or more hulls.

In accordance with a further embodiment, a sailboat comprises: two or more hulls; a plurality of sails, and wherein the plurality of sails includes one or more foresails; and a system for sailing windward, which includes two or more foresail tracks, each of the two or more foresail tracks is configured to receive a leading edge of a foresail, and wherein each of the foresail tracks extend from one of the two or more hulls to another of the two or more hulls.

In accordance with another exemplary embodiment, an extendable keel comprises: a fixed inner member; a moveable outer member, the moveable outer member surrounding the fixed inner member; a foil member attached to the outer member; and a control system for lowering or retracting the outer member.

In accordance with a further exemplary embodiment, an inflatable solar panel support, the support comprises: a lower section having an inlet and an outlet for filling and draining water from the lower section; an upper section having an inlet and an outlet for inflating and deflating the upper section, and wherein the upper section has a horizontal base, and a pair of angled sides, which join together forming an angled surface having at least one cavity, which receives a solar panel; and a rechargeable battery, which receives a source of electrical power from the solar panel housed within the lower section and stores the source of electrical power.

In accordance with another exemplary embodiment, wind turbine comprises: a base; a tower, the tower having a cavity therein, which houses a rechargeable battery, and one or more blades, which produce a source of electricity, which is stored in the rechargeable battery housed in the tower of the wind turbine.

### BRIEF DESCRIPTION OF THE DRAWINGS

FIG. 1 is a perspective view of a sailboat with a system and method of adjusting the location and position of the foresail in accordance with one embodiment.

FIG. 2 is a top view of the sailboat of FIG. 1 with a system and method of adjusting the location and position of the foresail.

FIG. 3A is a schematic view of a sailboat in accordance with one embodiment with a system and method of adjusting the location and position of the foresail in comparison with a sailboat without a system and method of adjusting the location and position of the headsail, jib, genoa, or spinnaker.

FIG. 3B is a schematic view of a sailboat without a system and method of adjusting the location and position of the foresail.

FIG. 4 is a cross-sectional view of a portion of the track system on a sailboat with a system and method of adjusting the location and position of the foresail.

FIG. 5 is a top view of a sailboat with a system and method of adjusting the location and position of the foresail in accordance with another embodiment.

FIG. 6 is a top view of a multi-hulled boat with a system and method of adjusting the location and position of the foresail in accordance with a further embodiment.

FIG. 7 is a top view of a multi-hulled boat with a system and method of adjusting the location and position of the foresail in accordance with another embodiment.

FIG. 8 is a top view of a multi-hulled boat having one or more track systems for adjusting the location and position of the foresail in accordance with a further embodiment.

FIG. 9 is a cross-sectional view of a portion of a sailboat with a fixed keel and an adjustable ballast or weight system in accordance with a further embodiment.

FIG. 10 is a cross-sectional view of a sailboat with a fixed keel in accordance with another embodiment.

FIG. 11 is a perspective view of an inflatable solar panel system in accordance with an embodiment.

FIG. 12 is a plan view of a portion of the inflatable solar panel system of FIG. 11 in accordance with an embodiment.

FIG. 13 is a perspective view of an inflatable solar panel system, which is designed to float in a body of water in accordance with an exemplary embodiment.

FIG. 14 is a perspective view of a system for transporting a plurality of inflatable solar panel systems.

FIG. 15 is a perspective view of a windmill in the form of a wind turbine in accordance with an exemplary embodiment.

FIG. 16 is a perspective view of a windmill in the form of a wind turbine in accordance with another exemplary embodiment.

FIG. 17 is a perspective view of a windmill in the form of a wind turbine in accordance with a further exemplary embodiment.

FIG. 18 is a perspective view of a wind and solar station in accordance with an exemplary embodiment.

FIG. 19 is a perspective view of a wind and solar city in accordance with an exemplary embodiment.

FIG. 20 is a perspective view of a system for loading and unloading of batteries stored within an electric vehicle in accordance with an exemplary embodiment.

### DETAILED DESCRIPTION

As described above, because of the design of the sails, a sailboat (or boat) 10 can sail to windward, in a direction no less than about 15 to 25 degrees from the wind, depending upon the design of the boat and the skill of the sailor. Headway directly upwind is achieved in a series of sequential maneuvers called tacks, in which the boat is first sailed windward with the wind over one side of the bow, and then turned through the wind so that the wind comes over the other side of the bow. In each tack, some headway upwind is achieved even though the boat does not move directly into the wind, and eventually the sailboat reaches an upwind objective after sailing a zig-zag course covering a distance greater than the straight line distance from the initial position to the upwind objective.

In addition, when a sailboat 10 sails to windward, the forces on the sails can be resolved into a thrust component that moves the sailboat forwardly through the water and a drift component that pushes the sailboat sideways in a downwind direction. The sailboat 10 therefore moves in a net direction that is forward, but also is slight downwind opposite to the net intended direction of movement. The sideways drift is called leeway.

The downwardly projecting centerboard or keel of the boat offers resistance to the leeway produced by the sideways sail force, but at least some leeway remains. This leeway is being constantly accumulated, as there is a downwind movement as long as the sailboat is being sailed into the wind. The leeway can significantly increase the time required for the sailboat to sail from its downwind starting position to the upwind objective, as it forces the sailboat to sail much further to make up for the accumulated sideways movement.

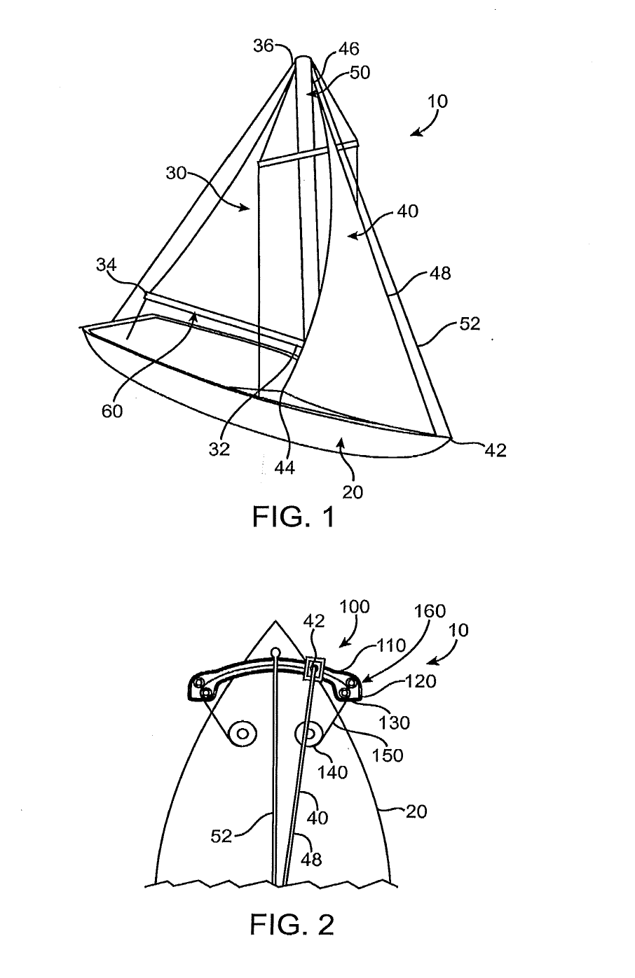

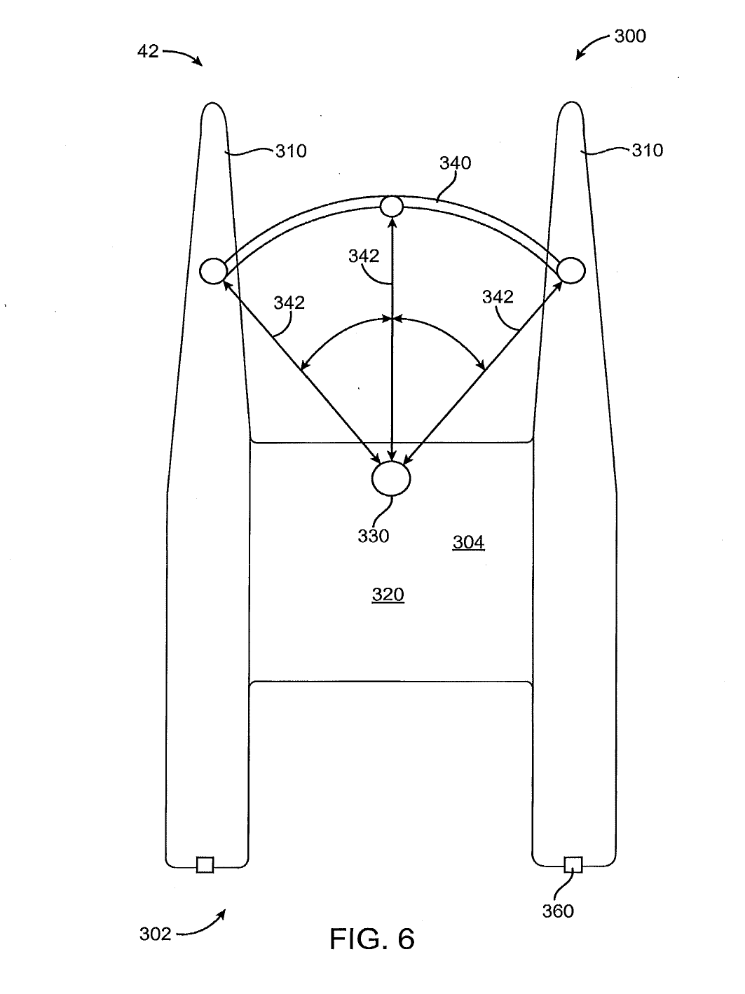

FIG. 1 shows a perspective view of a sailboat 10 with a system and method of adjusting the location and of at least one of the sails 40 of the sailboat 10, and more particularly a system and method of adjusting the foresail 40 (or headsail, jib genoa, or spinnaker) in accordance with one embodiment. As shown in FIG. 1, a sailboat 10 typically includes a hull 20 that sits in the water, a mast 50 extending upwardly from the hull 20, and at least one sail in the form of a mainsail 30 supported by the mast 50 and a boom 60, and an optional centerboard or keel 70 (FIG. 6)) extending downwardly from the hull 20 into the water. Typically, most sailboats 10 also include a second sail 40 in the form of a foresail, jib, genoa, or spinnaker. The sails 30, 40 catch the wind and cause the hull 20 to move forwardly through the water. The sailboat can also include a mainstay 52, which preferably extends from an upper portion of the mast 50 to the bow 42 of the sailboat 10.

The use of the term “sailboat” 10 has a broad meaning and can include yachts, (large sailboats) and smaller vessels of many configurations, which use wind as the primary means of propulsion. Typically, some of the variations other than size are hull configuration (monohull, catamaran, and trimaran), keel type (full, fin, wing, centerboard etc.), purpose (sport, racing, cruising), number and configuration of masts, and the sail plan. The most common sailboat 10 is the “sloop” which features one mast 50 and two sails, a mainsail 30 and a foresail 40 or jib, genoa, or spinnaker. This simple configuration has been proven over time to be very efficient for sailing into the wind. The mainsail 30 is attached to the mast 50 and the boom 60, which is a beam or spar capable of swinging across the sailboat 10, depending on the direction of the wind. Depending on the size and design of the foresail 40, the foresail 40 is called a jib, genoa, or spinnaker. Although not common, a sloop or sailboat 10 can include two foresails from a single forestay 48 at one time (wing on wing). The forestay 48 is a line or cable running from near the top of the mast 50 to a point near the bow 42 (or front of the sailboat 10). The forestay 48 is attached at either the top of the mast, or in fractional rigs between about ¼ and ⅛ from the top of the mast 50. The other end of the forestay 48 is attached to the stern or bow 42 of the boat 10. The forestay 48 can be made from stainless steel wire, a solid stainless steel rod, a carbon rod, a galvanized wire or natural fibers.

As shown in FIG. 1, the mainsail 30 is attached to the mast 50 and the boom 60. The boom 60 is typically a metal or wooden beam or spar, which is configured to stabilize the bottom of the mainsail 30. The boom 60 is attached to the mast 50 at a lower end 32 of the mast 50 and extends towards the stern 43 (or back of the sailboat 10). An outhaul or line 34, which is part of the running rigging of a sailboat 10, is used to extend the mainsail 30, and control the shape of the curve of the foot of the mainsail 30. The outhaul 34 runs from the clew (the back corner of the sail 30) to the end of the boom. The line is pulled taut to the appropriate tension (to provide the desired shape to the foot), and then secured to a cleat on the boom 60. The mainsail 30 is also attached to the top 36 of the mast 50. The mainsail 30 extends aftward and is secured the whole length of its edges to the mast 50 and to the boom 60 hung from the mast 50.

The foresail 40, which is also known as a headsail, jib, genoa, or spinnaker is secured to the top 46 of the mast 50 and is typically secured to the bow 42 of the sailboat 10. Typically, the foresail 40 is secured along its leading edge to a forestay 48 (strong wire) strung from the top 46 of the mast to the bowsprit 42 on the bow (nose) of the boat. Alternatively, the foresail 40 can be a genoa, which is a type of jib that is larger, and cut so that it is fuller than an ordinary jib. It can also be appreciated that fore-and-aft sails can be switched from one side of the sailboat 10 to the other, in order to alter the sailboat's course. When the sailboat's stern crosses the wind, this is called jibing; when the bow crosses the wind, it is called tacking. Tacking repeatedly from port to starboard and/or vice versa, called “beating”, is done in order to allow the boat to follow a course into the wind.

It can be appreciated that a primary feature of a properly designed sail is an amount of “draft”, caused by curvature of the surface of the sail. When the sail is oriented into the wind, this curvature induces lift, much like the wing of an airplane. Modern sails are manufactured with a combination of broadseaming and non-stretch fabric. The former adds draft, while the latter allows the sail to keep a constant shape as the wind pressure increases. The draft of the sail can be reduced in stronger winds by use of a Cunningham and outhaul, and also by increasing the downward pressure of the boom by use of a boom yang. A boom yang is a line or piston system on a sailboat used to exert downward force on the boom and thus control the shape of the sail. In British English, it is known as a “kicking strap”. The yang typically runs from the base of the mast 50 to a point about a third of the way out the boom 60. Due to the great force necessary to change the height of the boom 60 while a boat is under sail, a line based boom yang usually includes some sort of a pulley system. Hydraulic piston vangs are used on larger sailboats and controlled by manual or electric hydraulic pumps.

FIG. 2 shows a top view of the sailboat 10 of FIG. 1 with a system and method of adjusting the location and position of the foresail 40. As described above, the foresail 40 is typically attached to the bow 42 of the sailboat 10 via the forestay 48. In accordance with one embodiment, as shown in FIG. 2, the foresail 40 can be, attached to a track system 100. The track system 100 is attached to the bow 42 of the boat 10 and is configured to change the location or position of the foresail 40 and the forestay 48 relative to the hull 20 of the boat 10 during a tacking maneuver.

Tacking typically describes the position of a sailboat's bow with respect to the wind. For example, if the vessel's bow is positioned so that the wind is blowing across the starboard (right) side of the vessel, then the vessel is said to be on a starboard tack. If the wind is blowing across the port (left) side of the vessel, then the vessel is said to be on a port tack. By definition, this is opposite to the side, which the boom is carried, since it can be difficult when a boat is sailing downwind or nearly downwind from which side the wind is coming. In addition, a sailing vessel on a starboard tack always has the right-of-way over another sailing vessel on “port tack” by both the rules of the road and racing rules.

The track system 100 preferably includes a moveable track fixture 110, upon which the forestay 48 is securely fixed or attached, a fixed track 120 configured to receive the track fixture 110, and a control system 130 for securing the location of the track fixture 110 within the track 120 relative to the bow 42 of the boat 10. In accordance with one embodiment, the control system 130 for securing the location of the track fixture 110 can include a winch 140, a flexible wire or rod 150 attached to the track fixture 110, and a guide system 160. The winch 140 is preferably a mechanical device that is used to wind up the flexible wire or rod 150 (also called “cable”). In its simplest form, it consists of a spool and attached crank. The spool can also be called the winch drum, that the winch 140 can include suitable gear assemblies and can be powered by electric, hydraulic, pneumatic or internal combustion drives. In addition, the winch 150 can include a solenoid brake and/or a mechanical brake or ratchet (not shown) that prevents the winch 150 from unwinding.

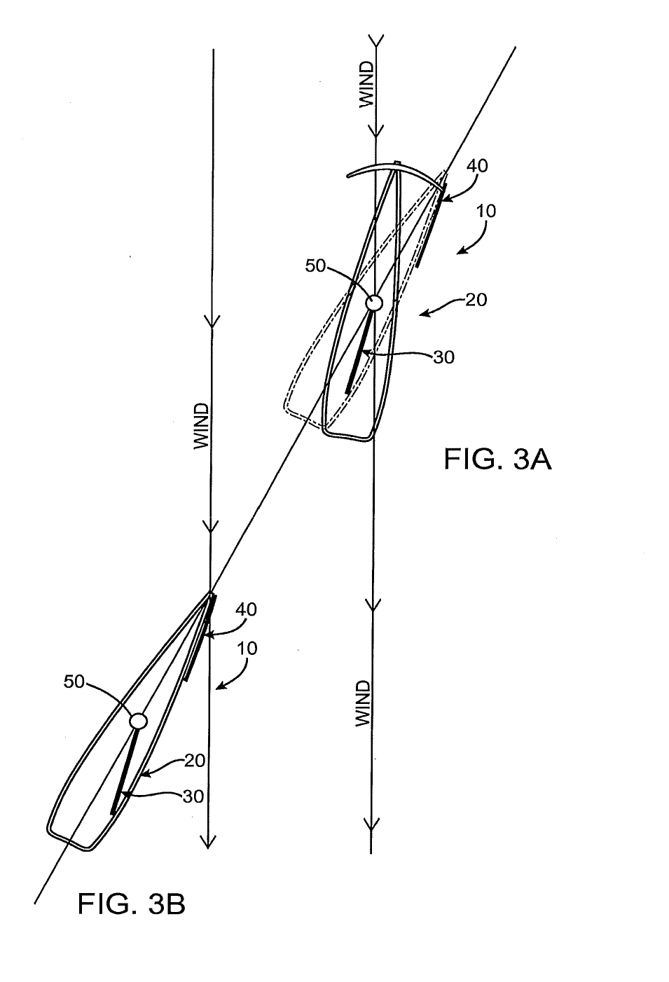

FIG. 3A shows a schematic view of a sailboat 10 in accordance with one embodiment with a system and method of adjusting the location and position of the foresail 40 in comparison with a sailboat 10 without a system and method of adjusting the location and position of the foresail 40. As shown in FIG. 3A, the control system 130 is configured to adjust or change the relative location of the foresail 40 to the bow 42 of the boat 10 during tacking maneuvers, such that the bow 42 of the boat 10 can sail into the wind more than if the foresail 40 and forestay 48 is fixed to the bow of the boat 10.

FIG. 3B shows a schematic view of a sailboat without a system and method of adjusting the location and position of the foresail. As shown in FIG. 3B, a typical sailboat 10 performs a tacking maneuver by sailing at an angle into the wind. However, as shown in FIG. 3A, if the relative position of the foresail 40 to the bow 42 of the boat 10 is changed or altered without change the relative position of the mainsail 30 and foresail 40 to one another, the bow 42 of the boat 10 can sail more into the wind resulting in a shorter distance or path of travel for the sailboat during tacking.

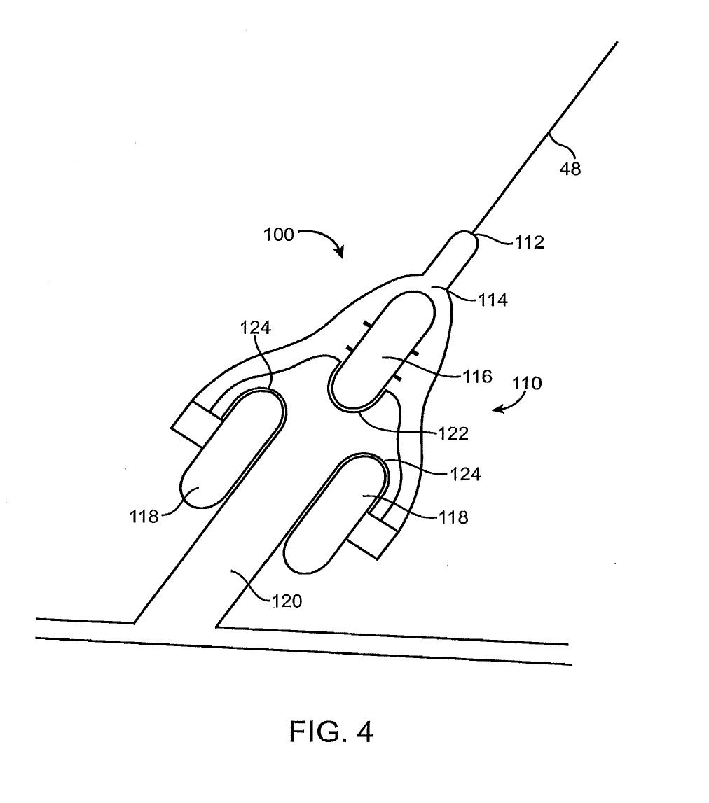

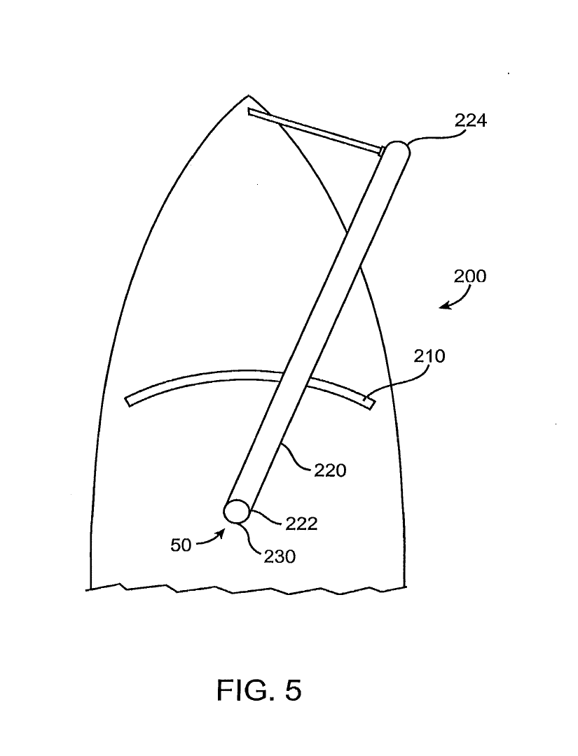

FIG. 4 shows a cross-sectional view of a portion of the track system 100 on a sailboat with a system and method of adjusting the location and position of the foresail 40 in accordance with one embodiment. The track system 100 preferably includes a track fixture 110, and a fixed track 120. The foresail 40 (not shown) is attached to the forestay 48, which is secured to the track fixture 110 at an upper end 112. As shown in FIG. 4, the track fixture 110 can include an upper end 112, a main body 114, an upper wheel 116, and a pair of lower wheels 118. The fixed track 120 can include an upper groove 122 configured to receive the upper wheel 116 and a pair of lower grooves 124 configured to receive the pair of lower wheels 118. The track fixture 110 moves from side to side (starboard to port) on the fixed track 120 resulting in the relative position of the forestay 48 (and the foresail 40) to the bow 42 of the boat 10 facing in a more windward direction during tacking maneuvers.

FIG. 5 shows a top view of a sailboat 10 with a system and method of adjusting the location and position of the foresail 40 in accordance with another embodiment. As shown in FIG. 5, a beam or spar system 200 comprised of a foresail track system 210, a foresail beam 220, and a pivot member 230. The foresail beam 220 is attached to the pivot member 230 (or mast 50) at one end (mast end) 222 and the other end (bow end) 224 of the foresail beam 220 moves from side to side (starboard to port). The foresail beam 220 is preferably attached to an optional foresail track system 210, which assists the foresail beam 220 in movement from side to side. The forestay 48 (not shown) is preferably securely fixed or attached to the bow end 224 of the foresail beam 220. In addition, a series of lines 226 can be used to control the bow end 224 of the foresail beam 220.

The system as shown in FIG. 5, the beam or spar system 200 can also include a control system 130 (not shown) comprised of a winch 140, a flexible wire or rod 150 attached to the track fixture 110, and a guide system 160. As described above, the winch 140 is preferably a mechanical device that is used to wind a wire rod or wire rope (also called “cable”). In its simplest form, it consists of a spool and attached crank. In addition, the winch 150 can also include gear assemblies and can be powered by electric, hydraulic, pneumatic or internal combustion drives. The winch 150 can also include a solenoid brake and/or a mechanical brake or ratchet, which prevents the winch 150 from unwinding.

FIG. 6 is a top view of a multi-hulled boat 300 with a system and method of adjusting the location and position of the foresail in accordance with a further embodiment. As shown in FIG. 6, the multi-hulled boat 300 consists of two or more hulls 310, joined by a structure 320, the most basic being a frame, or other suitable structure, which spans from one hull 310 to the other hull 310. The multi-hulled sailboat 300 can be sail and/or engine-powered. In accordance with an exemplary embodiment, the two or more hulls 310 can have two differently shaped or sized hulls with lateral symmetry, or alternatively, two or more hulls with longitudinal symmetry. For example, a trimaran has a main hull 310 in the center and symmetric stabilizing hulls 310 on either side. The boat 300 also includes one or more rudders 302 to guide the boat 300.

It can be appreciated that a multi-hulled sailboat can have several advantages compared to a single-hull boat. For example, by increasing the distance between the center of gravity and the center of buoyancy provides higher stability compared to boats with a single hull, which allows multi-hulls to have narrower hulls and thus substantially less wave-forming resistance, which in turn results in greater speed without applying more effort. In the case of boats under sail, stability serves to hold the vessel upright against the sideways force of the wind on the sails. This stability is provided in multi-hulls by the weight of the boat itself, in contrast to mono-hull sailboat, which typically uses an underwater counterweight, a ballasted keel for this purpose, especially on larger sailboats. Multi-hull sailboats are typically much wider than the equivalent mono-hull, which allows them to carry no ballast, and the reduced weight also makes them faster than mono-hulls under equivalent conditions. It can also be appreciated that multi-hulls typically will not sink or be abandoned if flooded, as opposed to ballasted mono-hulls who do indeed sink when flooded. In addition, the comfort of more onboard accommodation space and more level boats under sail offer substantially improved conditions for crew and passengers, which contributes to the greatly increasing popularity of multi-hull sailboats during the past few decades.

As shown in FIG. 6, in accordance with an exemplary embodiment, the multi-hulled boat 300 includes a mast 330 and a track system 340. As described above, a leading edge of the foresail 40 is attached to the track system 330, which extends from one hull 310 to another hull 310. The track system 340 preferably has an arc shape thereto, which mirrors the movement of a leading edge of the foresail 40 during tacking maneuvers, such that the distance 342 from the mast 330 to the track system 340 remains constant at all times. In accordance with one embodiment, as shown in FIG. 6, the foresail 40 (FIG. 2) can be attached to the track system 340. The track system 340 is attached to each of the hulls 310 of the boat 300 and is configured to change the location or position of the foresail 40 relative to the hulls 310 of the boat 300 during a tacking maneuver. It can be appreciated that tacking typically describes the position of a sailboat's bow with respect to the wind. For example, if the vessel's bow is positioned so that the wind is blowing across the starboard (right) side of the vessel, then the vessel is said to be on a starboard tack. If the wind is blowing across the port (left) side of the vessel, then the vessel is said to be on a port tack. It can be appreciated that by definition, this is opposite to the side, which the boom is carried, since it can be difficult when a boat is sailing downwind or nearly downwind from which side the wind is coming. In addition, a sailing vessel on a starboard tack always has the right-of-way over another sailing vessel on “port tack” by both the rules of the road and racing rules.

The track system 340 preferably includes a moveable track fixture 110 as shown in FIG. 2, upon which the forestay 48 is securely fixed or attached, a fixed track 120 configured to receive the track fixture 110, and a control system 130 for securing the location of the track fixture 110 within the track 120 relative to the bow 42 of the boat 10. In accordance with one embodiment, the control system 130 for securing the location of the track fixture 110 can include a winch 140, a flexible wire or rod 150 attached to the track fixture 110, and a guide system 160. The winch 140 is preferably a mechanical device that is used to wind up the flexible wire or rod 150 (also called “cable”). In its simplest form, it consists of a spool and attached crank. The spool can also be called the winch drum. The winch 140 can include suitable gear assemblies and can be powered by electric, hydraulic, pneumatic or internal combustion drives. In addition, the winch 150 can include a solenoid brake and/or a mechanical brake or ratchet (not shown) that prevents the winch 150 from unwinding.

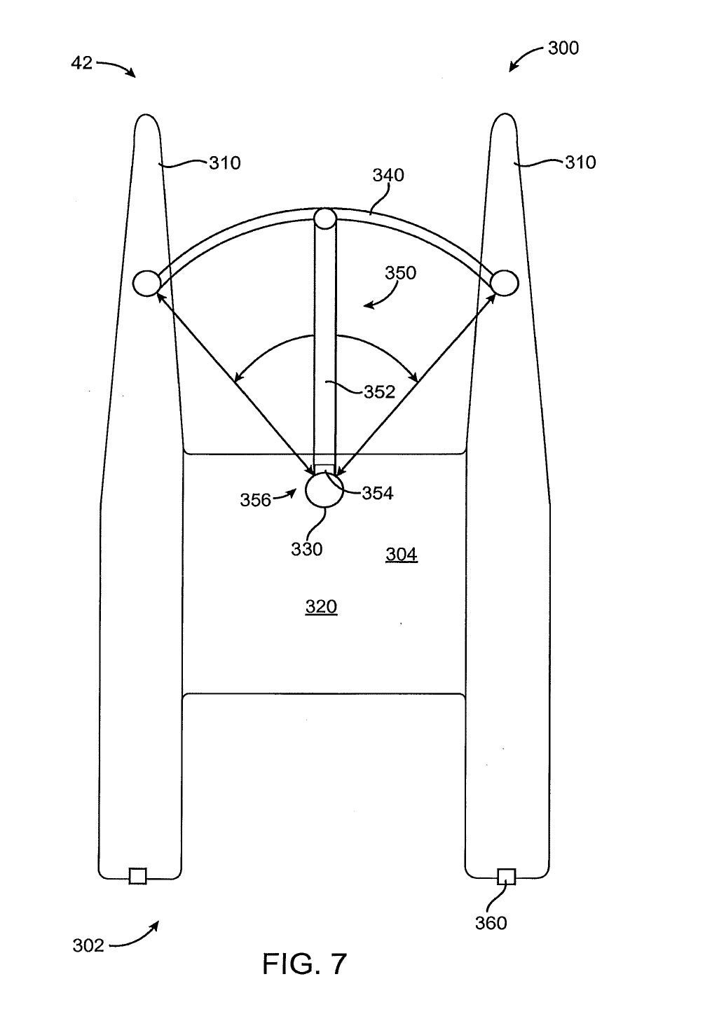

FIG. 7 shows a top view of a multi-hull boat 300 with a system and method of adjusting the location and position of the foresail 40 in accordance with another embodiment. As shown in FIG. 7, a beam or spar system 350 comprised of a foresail track system 340, a foresail beam 352, and a pivot member 354. The foresail beam 352 is attached to the pivot member 354 (or mast 330) at one end (mast end) 356 and the other end (bow end) 358 of the foresail beam 352 moves from side to side (starboard to port). The foresail beam 352 is preferably attached to a lower portion of the mast 330 and extends approximately horizontal to a deck 304 of the boat 300. The foresail (not shown) includes a leading edge (or clew or free end), which is attached to the bow end 358 of the foresail beam 352, a trailing edge, and a top edge (or head), which is generally attached to an upper portion of the mast 330.

In accordance with another exemplary embodiment, the foresail beam 352 is preferably attached to an optional foresail track system 340, which assists the foresail beam 352 in movement from side to side. The forestay 48 (not shown) is preferably securely fixed or attached to the bow end 358 of the foresail beam 352. The system as shown in FIG. 7, the beam or spar system 350 can also include a control system 130 as shown in FIG. 2 comprised of a winch 140, a flexible wire or rod 150 attached to the track fixture 110, and a guide system 160. As described above, the winch 140 is preferably a mechanical device that is used to wind a wire rod or wire rope (also called “cable”). In its simplest form, it consists of a spool and attached crank. In addition, the winch 150 can also include gear assemblies and can be powered by electric, hydraulic, pneumatic or internal combustion drives. The winch 150 can also include a solenoid brake and/or a mechanical brake or ratchet, which prevents the winch 150 from unwinding.

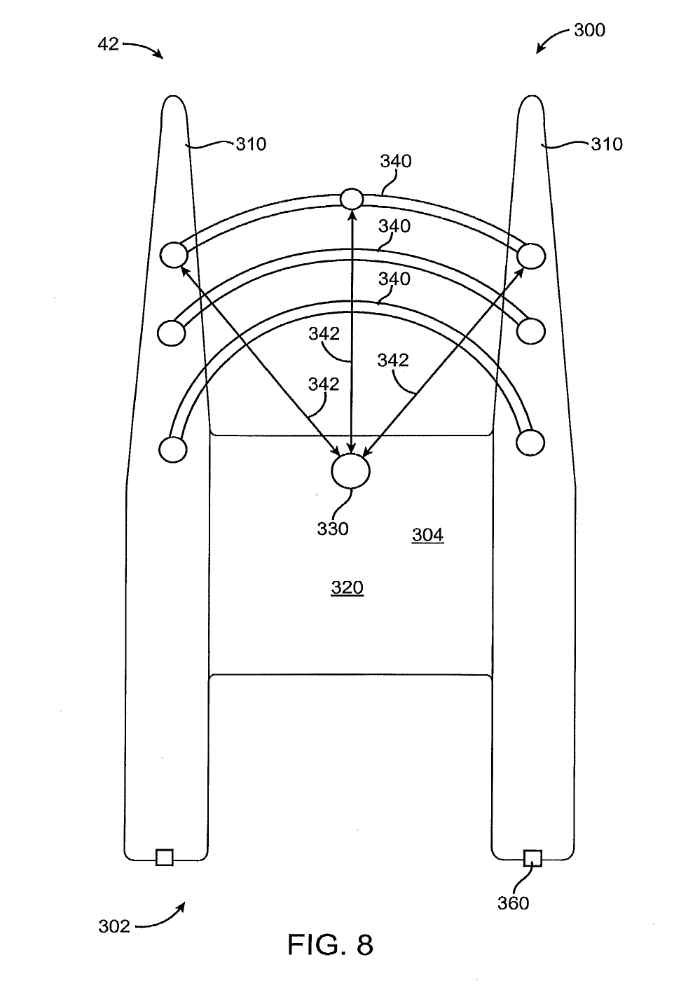

FIG. 8 is a top view of a multi-hulled boat 300 having one or more track systems 340 for adjusting the location and position of the foresail in accordance with a further embodiment. As shown in FIG. 8, the sailboat 300 includes a plurality (i.e., two or more) track system 340, each of the track systems 340 configured to receive a foresail 40 (not shown). Each of the track systems 340 extends from one hull 310 to another hull 310. The track system 340 preferably has an arc shape thereto, which mirrors the movement of a leading edge of the foresail 40 during tacking maneuvers, such that the distance 342 from the mast 330 to each of the track systems 340 remains constant at all times. The track systems 340 are attached to each of the hulls 310 of the boat 300 and are configured to change the location or position of the foresail 40 relative to the hulls 310 of the boat 300 during a tacking maneuver. In accordance with an exemplary embodiment, each of the track systems 340 can also include a beam or spar system 350 as shown in FIG. 8. If one or more beam or spar systems 350 (FIG. 8) are used, each of the foresail beams 352 are preferably at a different height relative to the deck 320 and/or mast 330 so that the foresail beams 352 can move freely. If the sailboat 300 has more than one foresail 40, depending on the conditions, one or more of the foresails 40 can be used at any time, such as during tacking maneuvers.

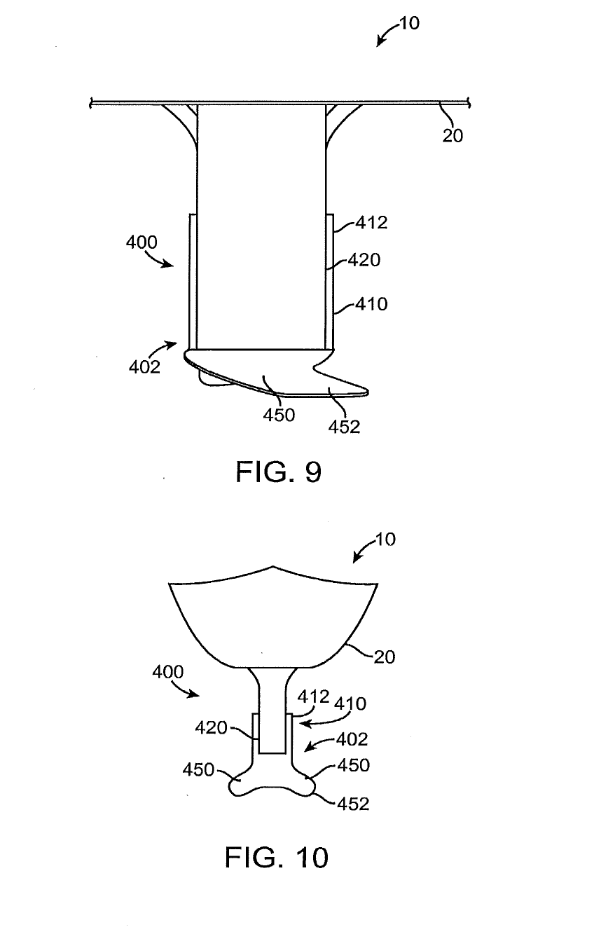

FIG. 9 shows a cross-sectional view of a portion of a sailboat 10 with an adjustable keel 400 in accordance with another exemplary embodiment. As shown FIG. 9, the sailboat 10 with an extendable keel 400 includes a foil member 450 (shown in a perspective view), an extendable outer member 470 and a fixed inner member 480. The foil member 450 is attached to the extendable outer member 470 and uses the forward motion of the boat 10 to generate lift to counter the lateral force from the sails (i.e., mainsail 30 and foresail 40). Sailboats 10 typically have much larger keels than non-sailing hulls, hi addition, the keel 400 is made of a heavy material to provide ballast to stabilize the sailboat 10. Accordingly, it would be desirable to have the ability to adjust the depth or length of the keel 400, which provides a righting moment of the sailboat 10 during tacking. Thus, the sailboat 10 will be quicker and will be faster during sailing competitions and/or races. In addition, the perpendicular distance from weight to pivot is increased. In addition, with the use of an extendable keel 400, a larger righting moment can be produced. The extendable keel 400 also provides for easier transportation of the sailboat 10 by retracting the keel 400 and allows for the sailboat 10 to sail in shallower water with the keel 400 retracted.

In accordance with another exemplary embodiment, the extendable outer member 410 is positioned on an exterior or outer portion of the fixed inner member 420. The outer member 410 has outer wall 412, which surrounds the fixed inner member 420, and can be raised and/or lower as needed. A suitable fit between the outer member 410 and the inner member 420 preferably exists such that the sailboat 10 does not take water on and the fit is suitable to withstand the corrosive environment that most sailboats 10 typically encounter. As shown in FIG. 9, the extendable outer member 410 is in a raised or retracted position, which surrounds the fixed inner member 420. Upon lowering or extending the outer member 410, the outer member extends further into the water or away from the hull 20 of the sailboat 10.

In accordance with one embodiment, the adjustable keel 400 also includes a control system (not shown), which includes a mechanical system, which controls the position of the outer member 410 relative to the fixed inner member 420, which in turn controls the depth of the adjustable keel 400. In accordance with one embodiment, the control system consists of a spool or drum and an attached crank. The control system also preferably includes suitable gear assemblies and/or can be powered by electric, hydraulic, pneumatic or internal combustion drives. The control system can also include a solenoid brake and/or a mechanical brake that prevents the system from unwinding and/or releasing from a fixed position.

As shown in FIG. 9, the keel 400 also preferably includes a foil member 450 having a winged foil 452 (or underwater wing) positioned on a distal end 402 of the keel 400. The foil member 450 with a winged foil 452 provides lift in a largely upwardly direction (rather than laterally, as for a leeway reducing keel) to reduce the wetted area of the hull 20 and thence its drag as the sailboat 10 moves forwardly.

FIG. 10 shows a cross-sectional view of a sailboat 10 with an adjustable keel 400 in an extended position with a winged keel 450 in accordance with another embodiment. As shown in FIG. 10, the sailboat 10 has an extendable keel 400, which includes a winged keel 450 having a foil member 452, an extendable outer member 410 and a fixed inner member 420. The winged keel 450 is attached to the extendable outer member 410 and uses the forward motion of the boat 10 to generate lift to counter the lateral force from the sails (i.e., mainsail 30 and foresail 40). As shown in FIG. 10, the outer wall 412 of the extendable outer member 410 is connected to the keel 400 and moves upward when the keel 400 is raised and moves downward when the keel 400 is lowered.

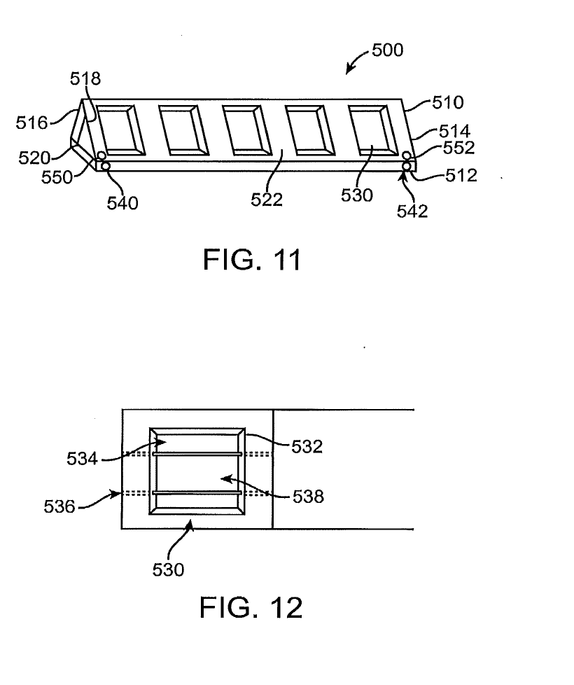

FIG. 11 is a perspective view of an inflatable solar panel support 500 in accordance with another exemplary embodiment. As shown in FIG. 11, the inflatable solar panel system 500 includes an inflatable support structure 510 comprised of a pair of inflatable and/or water-filled sections 512, 514. In accordance with an embodiment, the lower section 512 includes an inlet 540, and an outlet 542 for filling and draining the water from the lower section 512. In an alternative embodiment, the upper section 514 has an inlet 550 and an outlet 552 for inflation and deflation of the upper section 514. The inlets 540, 550 and the outlets 542, 552 are preferably one-way valves in the form of a relief valve or other suitable valving arrangement.

In accordance with one embodiment, the lower section 512 is preferably water fillable and holds water to weight the support 500. The upper section 514 is preferably air fillable and normally holds air to shape the support structure 510. The upper section 514 preferably has a horizontal base 520, and a pair of angled sides 516, 518, which join together forming an angled surface 522 having at least one cavity 530, which receives a solar panel (not shown). In accordance with one embodiment, the solar panel is preferably any suitable panel or array of smaller panels, which converts sunlight into a source of energy or energy source.

The solar panel support 500 is preferably portable and compresses and folds for easy transport. To set up the support 500, the lower section 512 is filled with a liquid or medium, such as water, and the upper section 514 is preferably inflated with a gas, such as air. In accordance with an embodiment, handles (not shown) can be provided on the lower and/or upper sections 512, 514. Lifting the handles lifts the upper section 514 and pre-inflates the upper section 514 with air.

In accordance with an embodiment, water fills at least a portion of the lower section 512. The filling of the lower section 512 with water can increase the air pressure within the upper section 514. In addition, the increased air pressure helps to shape the upper section 514. In accordance with one embodiment, the lower section 512 has vents (not shown) in fluid communication with the upper section 514. The vents release excess pressure from the lower section 512. The vents also guide air from the lower section 512 into the upper section 514 as the liquid or medium (e.g., water) fills the pre-shaped lower section 512. This increases the air pressure in the upper section 514 and enables the upper section 514 to become rigid to shape and support the lower section 512. Air pressure also shapes the upper section 514 to inhibit the solar panels 538 (FIG. 12) from being displaced from the support 500.

As shown in FIG. 12, the inflatable solar panel support 500 includes at least one cavity 530, which is adapted to receive a solar panel 538. The solar panel 538 is preferably an array of solar-thermal panels or photovoltaic (PV) modules, or other suitable solar panel, which converts sunlight into an energy source. The at least one cavity 530 includes a base 534 and a plurality of vertical or angular edges 532, which forms an outer perimeter of the cavity 530. In accordance with one embodiment, a pair of elastic straps 536 can be added to each of the cavities 530 and/or alternatively, a pair of elastic straps 536 can extend across the angled sections 516, 518 of the upper section 514 to provide a means to retain the solar panel 538 within each of the cavities 530.

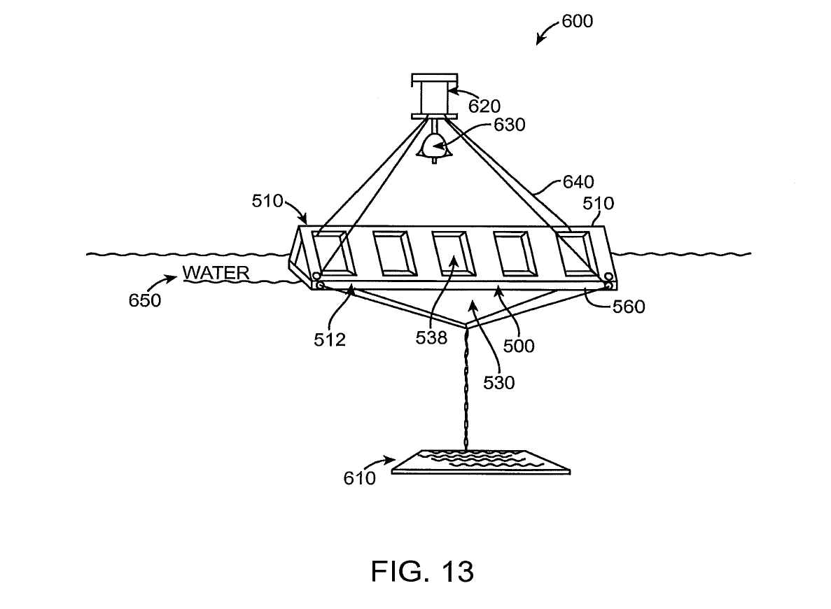

FIG. 13 is a perspective view of an inflatable solar panel system 600, which is designed to float in a body of water 650 in accordance with another exemplary embodiment. The inflatable solar panel system 600 includes one or more solar panel supports 500, and an anchor (e.g., weight) 610, which secures the system 600 to an area within the body of water (not shown). The system 600 can also be equipped with a light 620 and/or warning system 630 in the form of a siren, a horn and/or a bell provides warning to oncoming ships and/or boaters of the existence of the inflatable solar panel system 600. The light 620 and warning system 630 are preferably positioned above and/or on an upper surface or portion 570 of the one or more solar panel supports 500. As shown in FIG. 13, the light 620 and warning system 630 is located above the one or more solar panel supports 500, however, the light 620 and warning system 630 can be located on an upper surface or portion 570 of the support structure 510. Alternatively, the system 600 can be designed without an anchor or weight 610 for use on land and/or structures wherein the system 600 will not float and/or drift away from a desired location.

In accordance with an exemplary embodiment, the inflatable solar panel system 600 is preferably deployed in a body of water 650, which is traveled by boats, ship and the like. The body of water can be any navigable waterway, river, steam, lake and/or ocean. The one or more solar panels supports 500 are preferably filled with air and/or water, and fixed or attached to an area within the body of water via the anchor 610. The lower section 512 is preferably water fillable and normally holds water to weight the support 500. However, in accordance with an alternative embodiment, the lower section 512 can be configured as a rechargeable battery 560, which preferably includes one or more cells, each cell housing preferably a pair of electrodes—one positive, one negative, which are immersed in a liquid (e.g., water) containing electrically charged particles, or ions. In accordance with an exemplary embodiment, the liquid is preferably water in the form of fresh and/or salt water, and the ions for example, can be sodium and chlorine. However, the lower section 512 can include other suitable liquids and/or materials, which can be used to form rechargeable batteries within the lower section 512, can be used.

In accordance with an exemplary embodiment, the liquid is preferably water in the form of fresh, salt water and/or a combination of fresh and salt water. Thus, in addition, to providing ballast to the support 510, the lower section 512 acts a water-based rechargeable battery 560 for storing electricity generated by the solar panels 538, which is then stored within the at least one cavity 530 of the support structure 510. In accordance with an exemplary embodiment, the at least one cavity 530 comprises a plurality of cavities.

In accordance with an exemplary embodiment, the lower section 512 includes one or more cells (or cavities), and preferably a plurality of cells (or cavities), which each house two electrodes and water in the form of fresh and/or salt water. The water is preferably added to the lower section 512 upon placement of the support structure 510 at the desired location. For example, in accordance with an embodiment, the support structure 510 can be transported to a remote location and the lower section 512 can be filled with water, which secures the support structure 512 to the desired location and forms a water-based rechargeable battery having one or more electrochemical cells that can store the electrical power or electricity generated by the solar panels.

In accordance with an exemplary embodiment, the lower section 512 preferably has material therein, which can provide a storage source (i.e., rechargeable battery, which includes one or more electrochemical cells that convert stored chemical energy into electrical energy) for the one or more solar panel supports 500. The lower section 512 is preferably made of a flexible metal material, and/or plastic or plastic like material that can house the materials, which form the battery. Each of the one or more solar panel supports 500 are preferably pre-wired and includes all the materials for a water-based battery include a cathode, which connects to the positive terminal, and an anode, which connects to the negative terminal. In accordance with an exemplary embodiment, a liquid medium in the form of fresh, salt and/or a combination of fresh and salt water is all that is needed to complete the rechargeable battery. During storage of the source of electrical power and/or electricity generated by the solar panel, a positive active material is oxidized, producing electrons, and the negative material is reduced, consuming electrons. These electrons constitute the current flow in the external circuit. The liquid medium (or electrolyte) may serve as a simple buffer for ion flow between the electrodes.

As described above, the cathode and anode form the electrode, which are preferably separated via a barrier, which prevents the electrodes from making contact with one another, and allowing electrical charges to flow freely between the cathode and anode. The medium (or electrolyte), preferably in the form of a liquid medium allows the electric charges to flow between the cathode and anode. In accordance with an exemplary embodiment, the liquid medium is preferably non-toxic. The lower section 512 also preferably includes a collector, which conducts the charge to the outside of the battery and through a load.

During use, when a load completes the circuit between the two terminals, the water-based battery produces electricity through a series of electromagnetic reactions between the anode, cathode and electrolyte. The anode experiences an oxidation reaction in which two or more ions (electrically charged atoms or molecules) from the electrolyte combine with the anode, producing a compound and releasing one or more electrons. At the same time, the cathode goes through a reduction reaction in which the cathode substance, ions and free electrons also combine to form compounds. The reaction in the anode creates electrons, and the reaction in the cathode absorbs them, such that the net product is electricity.

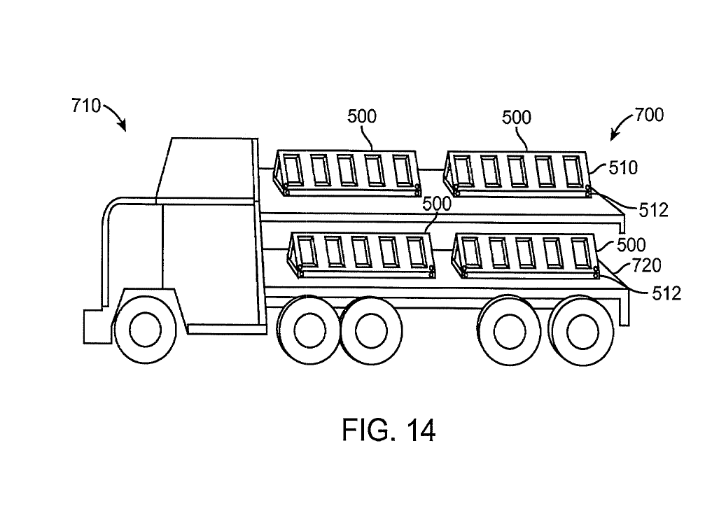

FIG. 14 is a perspective view of a system 700 for transporting a plurality of inflatable solar panel systems 500. As shown in FIG. 14, the system 700 includes a truck 710, which has a flat bed and/or deck 720 for transporting one or more support structures 510. The plurality of support structures 510 are preferably placed on the flat bed and/or deck 720 in a partially filled manner or a fully filled manner, which prevents the support structures 510 from sliding around and allows the structures 510 can be delivered to the site in a complete or ready to use manner. In accordance with an exemplary embodiment, no foundation and/or additional straps or tie downs are needed since the weight of the lower section 512 secures each of the support structures 510 to the flat bed and/or deck 720 of the truck during transportation of the structures 510. Alternatively, if the support structures 510 do not contain water within the lower section 512 and/or additional precautions are needed due to the terrain and/or distance in which the structures 510 are to be transported, the structures can be tied down or secured to the truck 710 as needed with ties and other suitable securing measures (not shown).

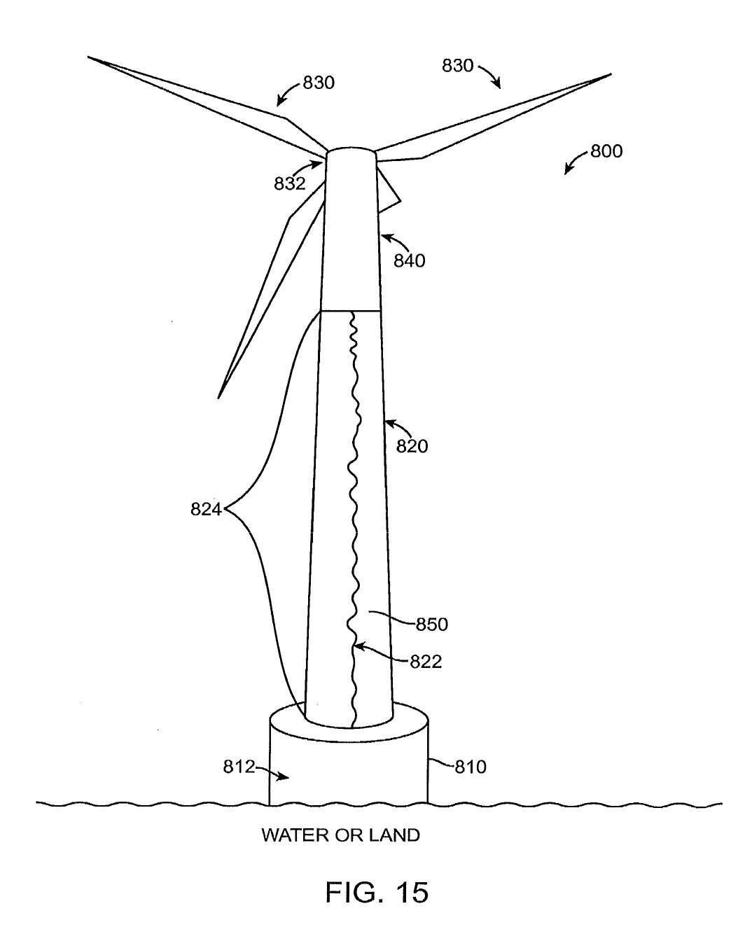

In accordance with another exemplary embodiment as shown in FIG. 15, a wind turbine (or windmill) 800 can be used to generate a source of electrical energy, and which can be stored on site until the generated energy is needed later by adding a storage system or battery within the base 810 or tower 820 of the wind turbine (or windmill) 800. Windmills or wind turbines 800 generally have either a vertical or a horizontal axis, and are built with a propeller-type rotor on a horizontal axis (i.e., a horizontal main shaft) in order that they may face directly into a wind. Most horizontal axis turbines include two or three-blades 830, although, windmills or wind turbines 800 can have between one to five or more blades 830. The rotor converts the linear motion of the wind into rotational energy that can be used to drive a generator.

In accordance with an alternative embodiment, the wind turbine 800 is a vertical axis wind turbine (“VAWT”) (not shown). Vertical-axis wind turbines are typically of a long axis type, allowing large columns of air to be harnessed. The two main types of VAWTs are the Savonius turbine, which is a high speed, low torque turbine, and the Darrieus turbine, which is a low speed, high torque turbine. The Darrieus turbine resembles an eggbeater, where two vertically oriented blades revolve around a vertical shaft. The Darrieus models use an airfoil design so that a wind turbine airfoil works in the same way as an airplane wing so that an airfoil has a flat side and a curved side. The result of air passing over the two sides is a force known as “lift,” One advantage to the vertical axis wind turbines is that the gear box and generators can be placed close to the ground, which makes these components easier to service and repair, and that VAWTs do not need to be pointed into the wind.

FIG. 15 is a perspective view of a windmill in the form of a horizontal wind turbine 800. Typically, windmills and/or wind turbines utilize wind created by the uneven heating of the atmosphere by the sun, the irregularities of the earth's surface, and rotation of the earth to generate a source of alternative or solar energy. In addition, wind flow patterns can be modified by the earth's terrain, bodies of water, and vegetation. In most windmills or wind turbines 800, the wind turns the blades, which spin a shaft, which connects to a generator and makes electricity. In most uses, a plurality of wind turbines generates electricity for the utility grid. The electricity is sent through transmission and distribution lines to homes, businesses, schools, and so on. As described above, most modern wind turbines fall into two basic groups: the horizontal-axis variety, as shown in FIGS. 15-18, and the vertical-axis design (not shown), like the eggbeater-style Darrieus model, named after its French inventor.

As shown in FIG. 15, horizontal-axis wind turbines 800 typically either have two or three blades. These two or three-bladed wind turbines operate “upwind,” with the blades facing into the wind. In accordance with an exemplary embodiment, it would be desirable to have a wind turbine 800 with an on-site water based rechargeable battery that can be used in connection with photovoltaic systems for use in remote, off-grid locations, where electricity is not available and/or connections to an utility grid is not available.

As shown in FIG. 15, a windmill 800 in the form of a wind turbine includes a base 810 having a tower 820 thereon, and one or more blades 830. The base 810 is preferably made of steel and/or concrete to support the tower 820 and the one or more blades 830. The tower 820 is preferably made from tubular steel (shown here), concrete, or steel lattice. Because wind speed increases with height, taller towers 820 enable turbines 800 to capture more energy and generate more electricity. As shown in FIG. 15, the wind turbine 800 preferably has either two or three blades 830, and wind blowing over the blades 830 causes the blades 830 to “lift” and rotate. In accordance with an exemplary embodiment, the blades 830 are preferably turned, or pitched, out of the wind to control the rotor speed and keep the rotor from turning in winds that are too high or too low to produce electricity.

The windmill 800 also preferably includes a nacelle 840, which sits atop the tower and contains the gearbox, low-speed and high-speed shafts, generator, controller, and brake. The gearbox houses the gears, which connect the low-speed shaft to the high-speed shaft. The low-speed shaft to high-speed shaft provides for an increase of the rotational speeds from approximately 30 to 60 rotations per minute (rpm) to upwards of approximately 1000 to 1800 rpm, which is the rotational speed required by most generators to produce electricity. A power line is preferably attached to the generator and can be positioned either within the tower 820 or alternatively, can be run on an exterior surface of the tower 820. Since gear boxes are often costly and heavy, in accordance with an exemplary embodiment, a direct-drive generator that operates at a lower rotational speed and does not require a gear box can also be used in place of a traditional gear box. The wind turbine 800 also preferably includes a controller, which aids with the start up of the wind turbine 800 at wind speeds of about 8 to 16 miles per hour (mph) and shuts off the machine at about 55 mph. In most cases, wind turbines 800 do not operate at wind speeds above about 55 mph because of the potential damage to the windmills that can occur with high-speed winds.

As shown in FIG. 15, the wind turbine 800 has a plurality of blades 830, and more preferably three blades 830, which are connected to a hub (not shown), which in combination with the blades 830 forms the rotor 832. In accordance with an exemplary embodiment, the wind turbine 800 includes a high-speed shaft drives the generator, and a low-speed shaft, which is turned by a rotor at about 30 to 60 rotations per minute. An “upwind” turbine, is so-called because it operates facing into the wind. Alternatively, other turbines can be designed to run “downwind,” facing away from the wind. The wind turbine 800 also preferably includes a wind vane (not shown), which measures wind direction and communicates with the yaw drive to orient the turbine properly with respect to the wind. The yaw drive is used to keep the rotor facing into the wind as the wind direction changes for upwind turbines, which face into the wind, and which is powered with a yaw motor. The wind turbine or windmill also preferably includes an anemometer, which measures the wind speed and transmits wind speed data to a controller. For emergencies, the wind turbine 800 is preferably equipped with a disc brake, which can be applied mechanically, electrically to stop the rotor.

As shown in FIG. 15, the tower 820 has a cavity (or hollow-out space or core) 822, which is configured to hold a liquid medium, such as water. In accordance with an exemplary embodiment, in remote locations, wherein water storage is limited, the cavity within the tower 820 can be configured to hold and/or store water. The cavity 822 preferably has a height 824 thereto, which can vary depending on the location of the wind turbine 800 and intended use and needs of the storage portion of the turbine 800. In addition, the base 810 can include a cavity 812 therein, which can also be used to store or hold a liquid medium, such as water.

In accordance with another exemplary embodiment, the cavity 812, 822 is configured as a rechargeable battery 850, which preferably includes one or more cells, each of the one or more cells housing a pair of electrodes—one positive, one negative, which are immersed in a liquid (e.g., water) containing electrically charged particles, or ions. In accordance with an exemplary embodiment, the liquid is preferably water in the form of fresh or salt water, and the ions for example, can be sodium and chlorine. However, the cavity 812, 822 can include other suitable liquids and/or materials, which can be used to form a rechargeable battery within the cavity 812, 822 of the base 810 or tower 820. The base 810 or tower 820 housing the water-based rechargeable battery 850 acts as a storage unit, which stores the generated electrical power, which can be transferred via wires to a power grid and/or saved for use by devices connected to the wind turbine 800. As described above in connection with FIG. 13, the wind turbine 800 houses a water-based rechargeable battery 850, which includes all the materials for a water-based battery including a cathode, which connects to the positive terminal, and an anode, which connects to the negative terminal. In accordance with an exemplary embodiment, a liquid medium in the form of fresh, salt and/or a combination of fresh and salt water completes the rechargeable battery 850. During storage of the source of electrical power and/or electricity generated by the rotating blades 830 of the wind turbine 800, a positive active material is oxidized, producing electrons, and the negative material is reduced, consuming electrons. These electrons constitute the current flow in the external circuit. The liquid medium (or electrolyte) serves as a buffer for ion flow between the electrodes. The cathode and anode form the electrode, which are preferably separated via a barrier, which prevents the electrodes from making contact with one another, and allowing electrical charges to flow freely between the cathode and anode. The medium (or electrolyte), preferably in the form of a liquid medium allows the electric charges to flow between the cathode and anode. In accordance with an exemplary embodiment, the liquid medium is preferably non-toxic. The wind turbine 800 can include a collector, which conducts the charge to the outside of the battery and through a load.

During use, when a load completes the circuit between the two terminals, the water-based battery produces electricity through a series of electromagnetic reactions between the anode, cathode and electrolyte. The anode experiences an oxidation reaction in which two or more ions (electrically charged atoms or molecules) from the electrolyte combine with the anode, producing a compound and releasing one or more electrons. At the same time, the cathode goes through a reduction reaction in which the cathode substance, ions and free electrons also combine to form compounds. The reaction in the anode creates electrons, and the reaction in the cathode absorbs them, such that the net product is electricity.

In addition, if the storage capacity of the battery housed within the base cavity 812, or tower cavity 822 is full, the excess generated electrical power (overage) from the wind turbine 800 can be sent to other wind turbines 800 having storage capacity or sold and/or transferred to a larger storage area or grid. In accordance with an exemplary embodiment, a trickle charger (not shown) can monitor the battery 850 of to ascertain whether the battery storage within the wind turbine 800 is operating properly.

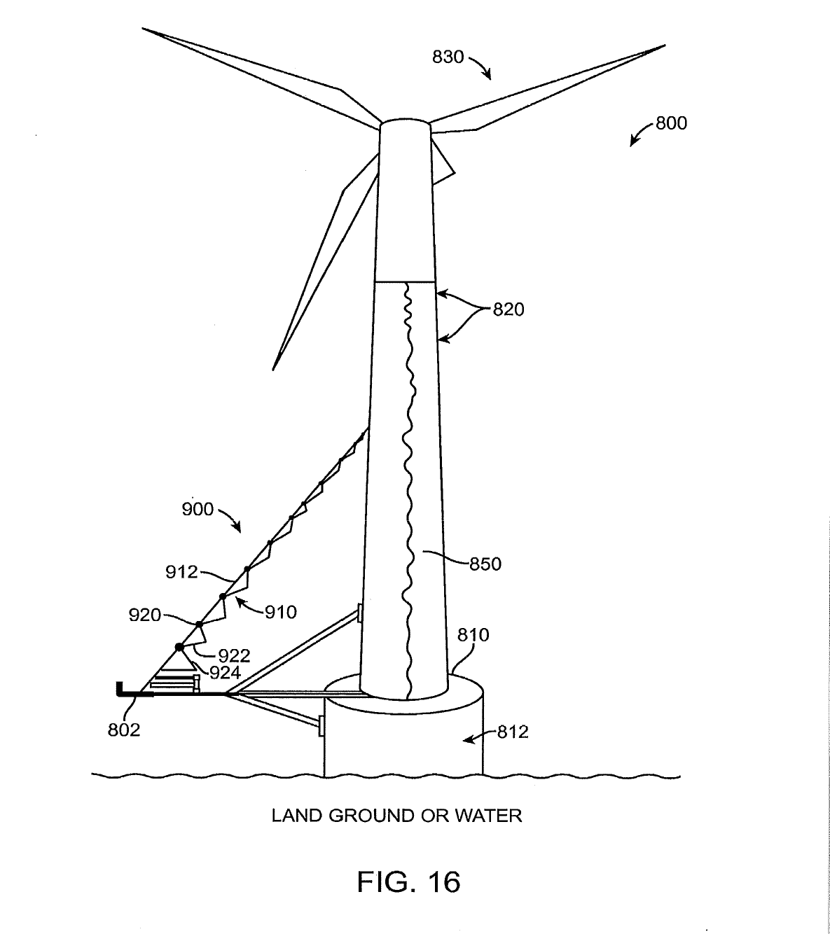

FIG. 16 is a perspective view of a windmill 800 in the form of a wind turbine in accordance with another exemplary embodiment. As shown in FIG. 16, the wind turbine 800 include one or more solar units 900 in the form a plurality of solar panels 910, which are attached to the tower 820 of the wind turbine 800. The plurality of solar panels 910 are preferably connected to the same power grid (not shown) as the wind turbine 800 and in combination with the wind turbine 800 produce a source of electrical power, which can be fed into the power grid and/or stored for later use within the wind turbine and/or separate storage facility. The solar panels 910 are preferably any suitable panel or array of smaller panels, which converts sunlight into an energy source. In accordance with an exemplary embodiment, any solar panel 910 can be used including flat solar thermal collector, such as a solar hot water or air panel used to heat water, air, or otherwise collect solar thermal energy, or any photovoltaic module, which is an assembly of solar cells used to generate electricity. The solar panels 910 are preferably flat, and can be various heights and widths. The solar panels 910 can be slightly curved or of a suitable flexible design. In addition, each solar panel 910 can be comprised of an array of solar-thermal panels or photovoltaic (PV) modules, which are be connected either in parallel or series depending upon the design objective.

In accordance with one embodiment, the one or more solar units 900 preferably include a plurality of solar panels 910, which are attached to the tower 820 via a wire and/or line 912, which extends from a lower portion or deck 802 of the windmill or wind turbine 800 upwards along the tower 820. The plurality of solar panels 910 are preferably attached or fixed to the wire and/or line 912 by a connector 920 such as a connecting rod or hook. The units 900 also includes a system for the unfolding the plurality of solar panels 910 and extending the connector 920 (i.e., connecting rod or hook) upward towards the windmill pr wind turbine 800.

In accordance with an exemplary embodiment, when not in use, the solar panels 910 can be retracted and stored on the ground or deck of the windmill 800. The system for extension and retraction of the solar panels 910 is preferably a suitable mechanical device (not shown) that can extend and retract the plurality of solar panels 910 as needed. In accordance with an exemplary embodiment, the mechanical device preferably includes a spool (or winch drum) and attached crank. The mechanical device or winch can be powered by electric, hydraulic, pneumatic or internal combustion drives, and includes a solenoid brake and/or a mechanical brake or ratchet that prevents it from unwinding.

The one or more solar units 900 are preferably controlled by a computer system (not shown), which receives information from a sensor and/or other device of the current weather conditions and/or needs of the wind turbine 800, to control the use of the panels (i.e., extension and retraction of the panels as needed). In addition, the plurality of solar panels 910 can be positioned on a rotatable member, which rotates with the relative position of the sun to maximize the production of electrical power from the plurality of solar panels 910.

A protective cover (not shown) can be placed over the stack of solar panels 910 during storage thereof or when the solar panels 910 are not in use. As shown in FIG. 16, a pair of solar panels 922, 924 are attached to each preferably via the connector 920, which preferably is a connecting rod or hook, and can include a pair of hinges, such that the plurality of solar panels 910 can be stored in a stack (i.e., z-fold) when not in use. As shown in FIG. 16, the panel system 900 comprises a pair of solar panels 922, 924 having a hinge between to allow the plurality of panels 910 to be stacked when not in use. The plurality of panels 922, 924 can also include at least one edge member (not shown), which assists with the alignment of the solar panels 910 during use. The at least one edge member is preferably a wire, a hook attaching the outer edge of the solar panels to one another or other suitable method of attaching the panels to one another.

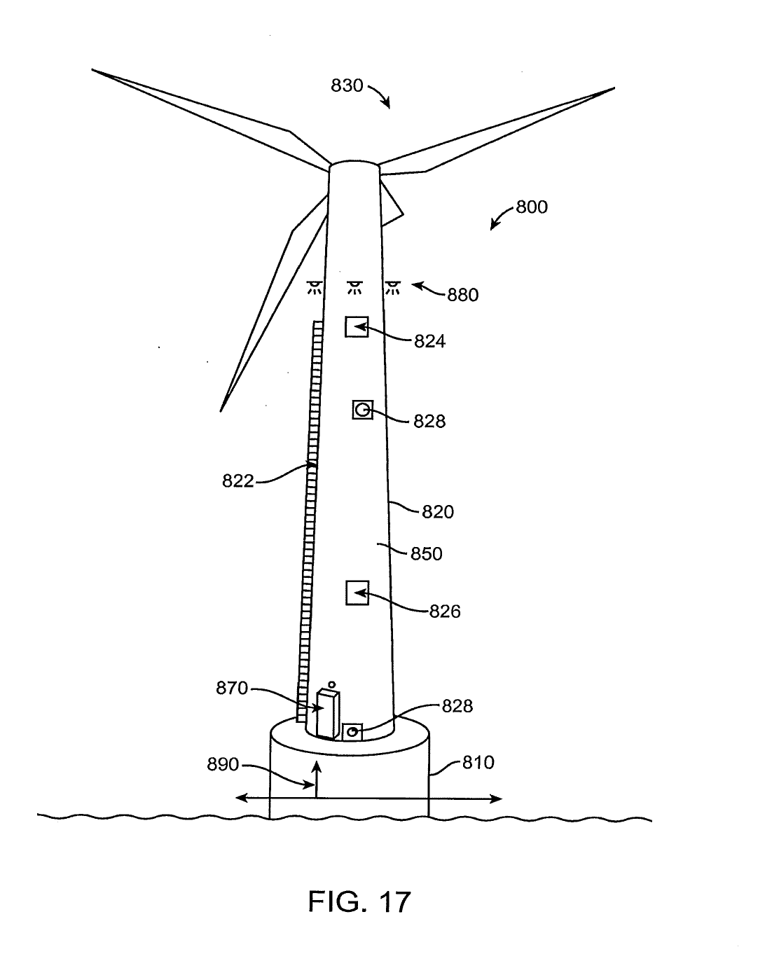

FIG. 17 is a perspective view of a windmill in the form of a wind turbine 800 in accordance with a further exemplary embodiment. As shown in FIG. 17, the tower 820 of the wind turbine 800 is equipped with an exterior ladder (outside the tower) 822 and/or an interior ladder (inside the tower) (not shown), which can be used to access the outside and inside of the tower portion 820 of the wind turbine 800 as needed. The tower 820 is also preferably equipped with one or more watertight doors and/or opening 824, 826, which are positioned on an upper portion and a lower portion of the tower 820, respectively. The one of more watertight doors and/or openings 824, 826, provide access to the tower cavity 822 as need for cleaning and/or other necessary maintenance. In addition, the tower 820 is also preferably fitted with one or more pump station fittings or connections 828, wherein liquid preferably in the form of water can be added and/or removed from an interior portion or cavity 822 of the tower 820 as needed. The tower 820 also includes an instrument control panel and system 870, which controls the wind turbine and/or battery portion of the wind turbine, which is house within the tower 820. The instrument control panel and system 870 can include a combined control panel and system for both the wind turbine 800 and the battery portion 850, or alternatively, two or more instrument control panels and systems 870 can be used, which control the wind turbine 800 and the battery 850 separately. In addition, the tower 820 has a ground system 880, which controls the electrical charge generated by the wind turbine and stored within the tower 820. The wind turbine 800 is attached to a power grid and/or other wind turbine via a cable 890, which transmits electrical current and/or power as needed and/or requested.

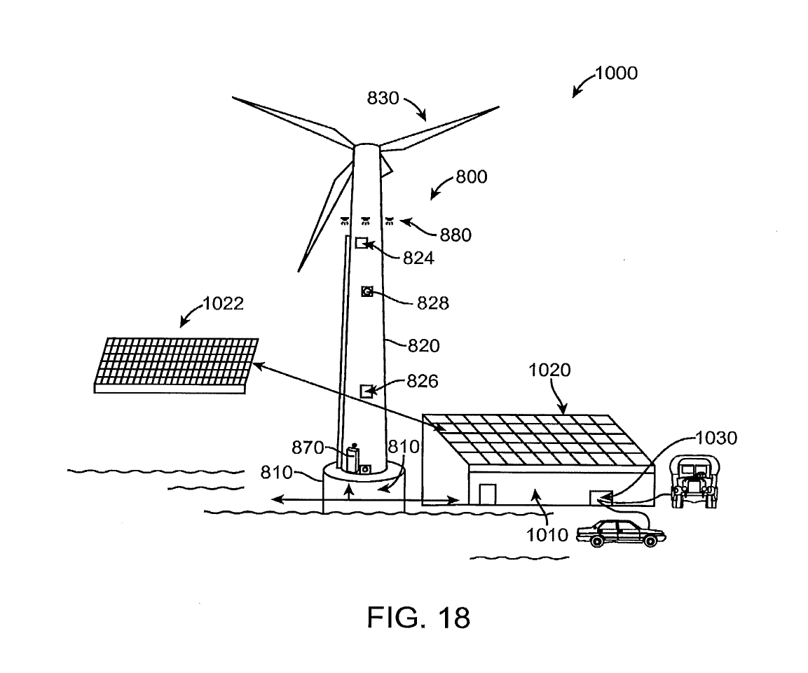

FIG. 18 is a perspective view of a wind and solar station 1000 in accordance with an exemplary embodiment. As shown in FIG. 18, the windmill station 1000 includes at least one wind turbine 800, at least one battery housing (or electrical storage facility) 1010, which includes optional solar panels 1020. The optional solar panels 1020 are preferably comprised of a plurality of solar arrays, which convert sunlight into electricity or electrical power. The optional solar panels 1020 are preferably placed on the roof or deck of the electrical storage facility 1010. In addition, optionally one or more solar support structures 510 as shown in FIGS. 11 and 12 can be used. The wind and solar station 1000 preferably is located in remote locations such that electric vehicles and the like can receive a source of electrical power as needed via a plug-in station 1030. The plug-in station 1030 is preferably attached and/or at least connected to the battery housing 1010. The battery housing 1010 preferably stores a source of electrical power generated from the one or more wind turbines 800. In accordance with an exemplary embodiment, the optional solar panels 1020 provide power in the form of electrical charge so as to maintain a constant or sufficient storage levels within the battery housing 1010 to meet the needs of the surround area and/or demands of any interconnected municipalities and/or other users of the stored electrical power.

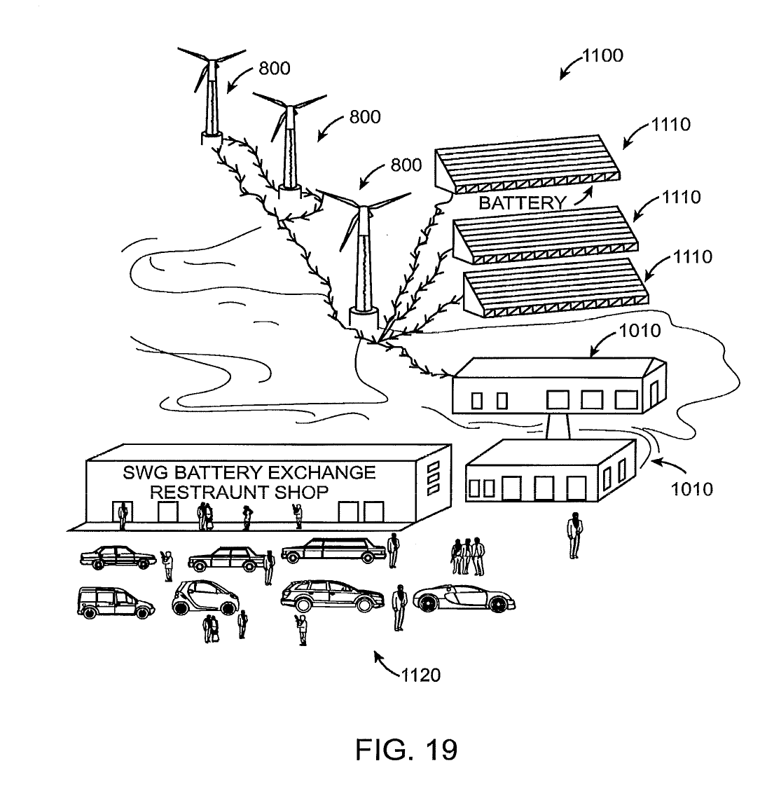

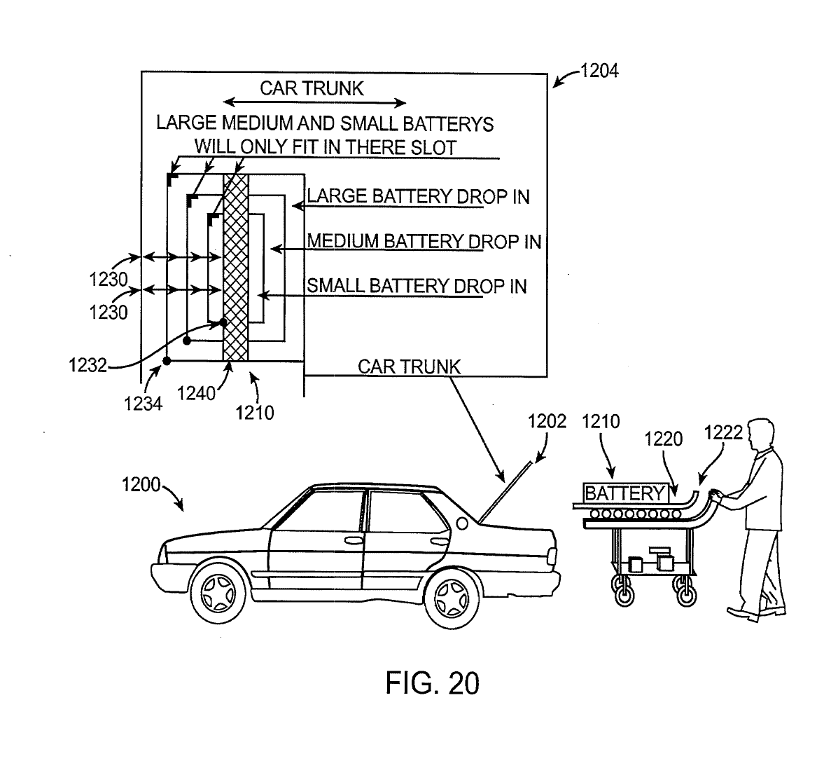

FIG. 19 is a perspective view of a wind and solar city 1100 in accordance with an exemplary embodiment. As shown in FIG. 19, the wind and solar city 1100 include one or more wind turbines 800, one or more battery housings 1010, and one or more optional solar panels arrays 1110. Each of the one or more wind turbines 800 and the one or more optional solar panel arrays 1110 are preferably connected to each other and supply either alternating current (AC) or direct current (DC) to the one or more battery housings 1010. The one or more wind turbines 800 generate a source of electricity, which is stored within the wind turbine 800 and/or alternatively, the source of electricity is transferred to the one or more battery housings 1010. In accordance with an exemplary embodiment, the direct current, or alternatively, alternating current can be provided to a battery supply warehouse 1110. The battery supply warehouse 1110 provides a rechargeable battery or battery source 1210 (FIG. 20), which station personnel remove and/or replace within an electric vehicle 1200. In addition, the battery supply warehouse 1110 can be used to charge and/or recharge used batteries.

In accordance with an alternative embodiment, rather than supply a source of direct current (DC), an alternating current (AC) can be used if the system requires. In addition, if one or more of the battery housings has excess or extra electrical power, the excess or extra electrical power can be supplied to a power grid, e.g., a municipal electric company. As shown in FIG. 19, each of the battery stations 1110 is preferably attaches or connects with at least one wind and solar power station 1100, which provides and/or services electric vehicles and the like 1120. In accordance with another exemplary embodiment, the generated electrical current or power can be transmitted through an insulated water line (not shown).

FIG. 20 is a perspective view of a system for loading and unloading of batteries, which power an electric vehicle or truck 1200 in accordance with an exemplary embodiment. As shown in FIG. 20, an electrical vehicle or truck 1200 preferably includes a removable or replaceable source of electrical power or battery 1210, which powers the vehicle or truck 1200. In accordance with an exemplary embodiment, the trunk 1202 of the vehicle 1200 has a housing 1204, which can receive a source of power or battery 1210, which can have one or more sizes. For example, the housing 1204 can be configured to receive a source of power and/or battery 1210 having one or more sizes, e.g., small, medium and/or large, or any other suitable destination of size, e.g., a certain number of volts. In accordance with an exemplary embodiment, the housing 1204 has a generally rectangular shape, which receives the source of electrical power and/or battery 1210 having a corresponding shape (e.g., rectangular).

As shown in FIG. 20, the housing 1204 has a plurality of electrical connections 1230, which are configured to receive a corresponding electrical connection (not shown) on a lower surface of the source of electrical power or battery 1210. After the source of electrical power or battery is placed within the housing 1204, in accordance with an exemplary embodiment, a pin or other like device 1232 can be inserted into a corresponding opening or hole 1234, which secures the source of electrical power or battery 1210 within the housing 1204. In accordance with an exemplary embodiment, the housing 1204 includes a center slot 1240, which guides the source of electrical power or battery 1210 in place. The center slot 1240 is preferably configured that sources of electrical power or batteries 1210 of different sizes can universally be placed within the housing 1204. In addition, the size of the source of electrical power or battery 1210 can determine the distance (e.g., number of miles) that the vehicle can travel before needing to be charged. In accordance with an exemplary embodiment, each of the sources of electrical power or batteries 1210 can universally be exchanged at all or most any wind and/or solar city 1100 having charging capabilities as described herein.

In accordance with another exemplary embodiment, the source of power or battery 1210 is manually loaded into the trunk of the vehicle 1200 using a battery loading device 1220 in the form of a hand cart 1222, which includes a manual system for loading and unloading of the source of power or battery into the trunk of the vehicle 1200. The loading device 1220 is configured such that when the source of electrical power (i.e., battery)) is in place, a handle is pull backwards or towards the operator, which advances the battery 1210 into the trunk of the vehicle 1200 and the center slot 1240 within the housing 1204. The loading device 1220 preferably includes one or more bearings, which allows the battery 1210 into the trunk of the vehicle. The loading device 1220 is also preferably designed to remove a source of electrical power or battery from the trunk 1202 of the vehicle or truck in a similar manner by pulling backwards on the handle of the loading device 1220, which dislodges the battery 1210 from the housing 1204 and places the battery 1210 on the deck of the loading device 1220.

The loading device 1220 is preferably configured to handle two or more batteries 1210, (i.e., “out with old in with the new”) such that the operator of the loading device 1220 needs to make only one trip to each of the vehicles 1200. For example, in accordance with an exemplary embodiment, the loading unit 1220 can be configured to house one battery 1210 on each side thereof. In addition, the loading device 1220 is preferably configured to load and unload batteries 1210 into any type of vehicle and/or truck 1200.

It will be understood that the foregoing description is of the preferred embodiments, and is, therefore, merely representative of the article and methods of manufacturing the same. It can be appreciated that many variations and modifications of the different embodiments in light of the above teachings will be readily apparent to those skilled in the art. Accordingly, the exemplary embodiments, as well as alternative embodiments, may be made without departing from the spirit and scope of the articles and methods as set forth in the attached claims.

1.-35. (canceled)

36. A method of storing power, the method comprising:
generating electrical power with at least one wind turbine in an area, the at least one turbine including a base, a tower supported on the base, at least one of the base or the tower having a cavity therein, which houses a rechargeable battery, and one or more blades;
storing the electrical power in the rechargeable battery housed in the cavity of the at least one of the base and the tower of the at least one first wind turbine;
sending excess electrical power from the at least one first wind turbine to at least one second wind turbine, the at least one second wind turbine having a base, a tower support on the base, at least one of the base and the tower having a cavity therein, which houses a rechargeable battery, and one or more blades; and
storing the excess electrical power in the rechargeable battery housed in the tower of the at least one second wind turbine.

37. The method of claim 36, comprising:
transferring the excess electrical power generated from the at least one first wind turbine to the at least one second wind turbine having storage capacity when the storage capacity of the at least one first wind turbine is full.

38. The method of claim 36, wherein each the rechargeable batteries include two electrodes, which are immersed in a liquid containing electrically charged particles.

39. The method of claim 36, further comprising:
producing the electrical power with a generator, which is connected to the one or more blades of the at one first wind turbine and the at least one second wind turbine.

40. The method of claim 39, comprising:
storing the electrical power within the rechargeable batteries housed in the base and the tower of the at least one first wind turbine or the at least one second wind turbine.

41. The method of claim 36, wherein each of the at least one first wind turbine and the at least one second wind turbine includes a nacelle, which sits atop the tower and contains a gearbox, low- and high-speed shafts, a generator, a controller, and/or a brake.

42. The method of claim 36, further comprising:
attaching one or more solar units in the form a plurality of solar panels to the tower of the at least one first wind turbine and the at least one second wind turbine via wire and/or line, which extends from a lower portion of the wind turbine upwards along the tower.

43. The method of claim 42, wherein the plurality of solar panels includes a system for the unfolding the plurality of solar panels and extending the plurality of solar panels upward towards an upper portion of the wind turbine, and wherein not in use, the solar panels can be retracted and stored in a z-fold stack.

44. The method of claim 36, comprising:
providing the electrical power to a power grid in electrical communication with the at least one first and the at least one second wind turbines.

45. The method of claim 44, comprising:
configuring the power grid configured to supply electrical power to homes, businesses, and/or schools.
